(19) United States
(12) Patent Application Publication
(10) Pub. No.: US 2009/0239756 A1
(43) Pub. Date: Sep. 24, 2009

(54) PREDICTORS FOR METASTASIS OF BREAST CANCER

(75) Inventors: Torben Kruse, Svendborg (DK); Mads Thomassen, Gudbjerg (DK); Qihua Tan, Odense C (DK)

Correspondence Address: MERCHANT & GOULD PC, P.O. BOX 2903, MINNEAPOLIS, MN, 55402-0903, US

(73) Assignee: Syddansk Universitet, Odense M (DK)

(21) Appl. No.: 12/396,906

(22) Filed: Mar. 3, 2009

Related U.S. Application Data
(60) Provisional application No. 61/037,397, filed on Mar. 18, 2008.

(51) Int. Cl. C40B 30/00; C40B 40/06

(52) U.S. Cl. 506/7; 506/16

(57) ABSTRACT

There is provided a gene expression pattern which is clinically relevant to metastasizing breast cancer. In particular, the identity of genes that are correlated with patient survival and breast cancer recurrence are provided. The gene expression profile, whether embodied in nucleic acid expression, protein expression, or other expression formats, may be used to predict survival of subjects afflicted with breast cancer and the likelihood of breast cancer recurrence. The invention thus provides for the use of a gene expression pattern (or profile or “signature”) which correlates with (and thus able to discriminate between) patients with good or poor survival outcomes.

This application claims benefit of Ser. No. 61/037397, filed Mar. 18, 2008 in the United States and which application is incorporated herein by reference. A claim of priority to the extent appropriate is made.

### FIELD OF THE INVENTION

The invention relates to the identification and use of a gene expression profile with clinical relevance to breast cancer. In particular, the invention provides the identities of genes that are correlated with patient survival and breast cancer recurrence. The gene expression profiles, whether embodied in nucleic acid expression, protein expression, or other expression formats, may be used to predict the survival of subjects afflicted with breast cancer and to predict breast cancer recurrence. The profiles may also be used in the study and/or diagnosis of breast cancer cells and tissue, including the grading of invasive breast cancer, as well as for the study and/or determination of prognosis of a patient. When used for diagnosis or prognosis, the profiles are used to determine the treatment of breast cancer based upon the likelihood of life expectancy and recurrence.

### BACKGROUND OF THE INVENTION

Breast tumors can be either benign or malignant. Benign tumors are not cancerous, they do not spread to other parts of the body, and are not a threat to life. They can usually be removed, and in most cases, do not come back. Malignant tumors are cancerous, and can invade and damage nearby tissues and organs. Malignant tumor cells may metastasize, entering the bloodstream or lymphatic system. When breast cancer cells metastasize outside the breast, they are often found in the lymph nodes under the arm (axillary lymph nodes). If the cancer has reached these nodes, it means that cancer cells may have spread to other lymph nodes or other organs, such as bones, liver, or lungs.

Major and intensive research has been focused on early detection, treatment and prevention. This has included an emphasis on determining the presence of precancerous or cancerous ductal epithelial cells. These cells are analyzed, for example, for cell morphology, for protein markers, for nucleic acid markers, for chromosomal abnormalities, for biochemical markers, and for other characteristic changes that would signal the presence of cancerous or precancerous cells. This has led to various molecular alterations that have been reported in breast cancer, few of which have been well characterized in human clinical breast specimens. Molecular alterations include presence/absence of estrogen and progesterone steroid receptors, HER-2 expression/amplification (Mark H E, et al. HER-2/neu gene amplification in stages I-IV breast cancer detected by fluorescent in situ hybridization. Genet Med; 1 (3):98-103 1999), Ki-67 (an antigen that is present in all stages of the cell cycle except G0 and used as a marker for tumor cell proliferation, and prognostic markers (including oncogenes, tumor suppressor genes, and angiogenesis markers).

Characterized by simultaneous profiling for the transcriptional activities of thousands of mRNA species in a human tissue, the DNA microarray technology represents an important high-throughput platform for analyzing and understanding human diseases. The tremendous potential provided by the new technology is serving us not only as a molecular tool for investigating disease mechanisms but also for classification and clinical outcome prediction (Dudda-Subramanya et al. 2003). Application of the technology in clinical oncology is demonstrating it as a powerful tool for refining diagnosis and improving prognostic prediction accuracy of cancer patients (Pusztai et al. 2003). Bioinformatics and biostatistics play important roles in such practices in establishing gene expression signatures or prognostic markers and in building up efficient classifiers (Asyali et al. 2006). Among the major issues in gene expression profile classification, feature selection is an important and necessary step in achieving and creating good classification rules given the high dimensionality of microarray data. There are various approaches for feature selection in the literature among which one common approach is the univariate selection scheme for selecting only genes with the highest statistical significance. Such an approach can be inadequate because (1) it tends to include elements that contribute highly redundant information and (2) it ignores the co-regulatory network in gene function. As a result, the univariate approach does not necessarily guarantee a best classifier (Ein-Dor et al. 2005; Baker and Kramer, 2006).

Tibshirani et al. (2002) proposed a Nearest Shrunken Centroids (NSC) method for both feature selection and tumor classification. In NSC, weak elements of the class centroids are shrunk or deleted via soft-thresholding to identify genes that best characterize each class. The method implemented in an R package (PAM, Prediction Analysis of Microarrays) performs well in identifying subsets of genes that can be used for classification and prediction. Although different feature selection methods have been reported for tumor classification (Inza et al. 2004), there has been no method specifically proposed for paired microarray experiments.

van's Veer et al. (Nature 415:530-536, 2002) describe gene expression profiling of clinical outcome in breast cancer. They identified genes expressed in breast cancer tumors, the expression levels of which correlated either with patients afflicted with distant metastases within 5 years or with patients that remained metastasis-free after at least 5 years.

Ramaswamy et al. (Nature Genetics 33:49-54, 2003) describe the identification of a molecular signature of metastasis in primary solid tumors. The genes of the signature were identified based on gene expression profiles of 12 metastatic adenocarcinoma nodules of diverse origin (lung, breast, prostate, colorectal, uterus) compared to expression profiles of 64 primary adenocarcinomas representing the same spectrum of tumor types from different individuals. A 128 gene set was identified.

Both of the above described approaches, however, utilize heterogeneous populations of cells found in a tumor sample to obtain information on gene expression patterns. The use of such populations may result in the inclusion or exclusion of multiple genes that are differentially expressed in cancer cells. The gene expression patterns observed by the above described approaches may thus provide little confidence that the differences in gene expression are meaningfully associated with breast cancer recurrence or survival.

As explained in more detail below the present invention is based on the increased expression of the genes FLJ20354, IMAGE:4081483, UBE2R2, ZNF533, and DTL. So far no prior art disclosure has envisaged that this gene profile is useful for the prediction of risk of metastasis.

WO06037485A2 discloses that 84 human genes, including FLJ20354, are differentially expressed in neoplastic tissue of breast cancer patients responding well to adjuvant CMF chemotherapy as compared to patients not responding well to adjuvant CMF chemotherapy. The document teaches that elevated or decreased levels of expression in one or several of the 84 genes at the time of tumor surgery or prior to any intervention (e.g. punch biopsy sample) was found to provide valuable information on whether or not a patient is likely to develop distant metastasis despite the given mode of chemotherapy.

WO05005601A2 discloses compositions and methods for treating, characterizing, and diagnosing cancer, including breast cancer. In particular, the document discloses gene expression profiles associated with solid tumor stem cells, as well as novel stem cell cancer markers useful for the diagnosis, characterization, and treatment of solid tumor stem cells. Although the document discloses gene expression profiles, including FLJ20354, it does not envisage prediction of metastasis based on the 5 differentially expressed genes of the present invention. Accordingly, the present invention also appears to be patentable over this prior art document.

WO04111603A2 discloses sets of genes, including FLJ20354, the expression of which is important in the prognosis of cancer. In particular, the document provides gene expression information useful for predicting whether cancer patients are likely to have a beneficial treatment response to chemotherapy. While this prior art document does not explicitly disclose that FLJ20354 may be used to predict the risk of metastasis it categorizes the gene as important in relation to the prediction of whether or not metastases will develop although chemotherapeutic treatment takes place. However, the present invention is based on the determination of 5 differentially expressed genes.

US20060183141A1 describes analysis of expression profile data to determine whether a pattern of expression or response will be predictive of cancer progression, including metastasis of breast cancer. Although the document discloses gene expression profiles, including FLJ20354, it does not envisage prediction of metastasis based on the 5 differentially expressed genes of the present invention.

US20040076955A1 discloses the use of IMAGE:4081483 in cancer diagnostics but not as predictor for metastasizing breast cancer. This document does not disclose a method for the prediction of metastasis based on the 5 differentially expressed genes of the present invention.

WO07016548A2 describes the identification of a breast cancer-specific signature of miRNAs that are differentially expressed in breast cancer cells, relative to normal control cells. An alteration (e.g., an increase, a decrease) in the level of the miR gene product in the test sample, relative to the level of a corresponding miR gene product in a control sample, is indicative of the subject either having, or being at risk for developing, breast cancer. Although the document discloses gene expression profiles, including UBE2R2, it does not envisage prediction of metastasis based on the 5 differentially expressed genes of the present invention.

Thomassen et al (Int. J. Cancer: 120, 1070-1075 (2006)) discloses a 32-gene profile, HUMAC32, which accurately predicts metastasis in low-malign breast cancer with a high degree of reliability.

WO06052218A1 discloses methods, systems, and compositions that provide a more useful measure of in vivo p53 functionality. These methods, systems, and compositions may be employed for the classification, prognosis, and diagnosis of cancers, including breast cancer. Specifically there is described a method for predicting disease outcome in a patient, the method comprising the steps of: obtaining gene expression profiles from a plurality of genes, including ZNF533, from tumor samples, wherein said tumor samples may be mutant or wildtype for the p53 gene; comparing said gene expression profiles to determine which genes are differentially expressed in the mutant or wild type tumors; deriving from said differentially expressed genes a set of genes to predict p53 mutational status; and using the set of genes to predict disease outcome in the patient. While this prior art does not explicitly disclose that ZNF533 may be used to predict the risk of metastasis it categorizes the gene as important in relation to the prediction of whether or not metastases will develop. However, the present invention is based on the determination of 5 differentially expressed genes.

WO9965928A2 describes the isolation of genes, including DTL, that are differentially expressed in primary or metastatic breast cancer. The compositions and methods of the present invention are particularly useful in diagnoses, prognoses and/or treatment of breast cancer. Although the document discloses gene expression profiles, including DTL, it does not envisage prediction of metastasis based on the 5 differentially expressed genes of the present invention.

van't Veer et al. (Nature, 415, 530-536 (2002)) discloses a 70-gene profile, including DTL which predicts metastasis in breast cancer with a high degree of reliability. Meanwhile the document does not disclose prediction of metastasis based on the 5 differentially expressed genes of the present invention.

The present inventors have developed a simple feature selection procedure based on a modified t-statistic to microarray experiments using the popular matched case-control design. Gene or feature selection is optimized by thresholding in a leaving one-pair out cross-validation procedure using the support vector machines (SVM) (Brown et al. 2000). Such an approach is necessary considering the advantages in a matched design because there are multiple factors (nodal status, tumor size, age, etc.) that convey important implications on tumor outcomes. Performance of the feature selection method is compared with that from PAM and from the ordinary paired t-test using receiver operating characteristics (ROC) analysis (Fawcett, 2006).

### SUMMARY OF THE INVENTION

The present invention relates to the use of a gene expression pattern (or profile or “signature”) which is clinically relevant to metastasizing breast cancer. In particular, the identity of genes that are correlated with patient survival and breast cancer recurrence are provided. The gene expression profile, whether embodied in nucleic acid expression, protein expression, or other expression formats, may be used to predict survival of subjects afflicted with breast cancer and the likelihood of breast cancer recurrence.

The invention thus provides for the use of a gene expression pattern (or profile or “signature”) which correlates with (and thus able to discriminate between) patients with good or poor survival outcomes.

The invention thus provides for the use of the gene expression pattern which correlates with the recurrence of breast cancer at the same location and/or in the form of metastases. The pattern is able to distinguish patients with breast cancer into at least those with good or poor survival outcomes.

The present invention provides a non-subjective means for the identification of patients with breast cancer as likely to have a good or poor survival outcome by assaying for the expression pattern disclosed herein. Thus where subjective interpretation may have been previously used to determine the prognosis and/or treatment of breast cancer patients, the present invention provides an objective gene expression pattern, which may be used alone or in combination with subjective criteria to provide a more accurate assessment of breast cancer patient outcomes, including survival and the recurrence of cancer. The expression pattern of the invention thus provides a means to determine breast cancer prognosis. Furthermore, the expression pattern can also be used as a means to assay, node negative tumors that are not readily assayed by other means.

The gene expression pattern comprises the genes defined in SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL), which is capable of discriminating between breast cancer outcomes with significant accuracy. The genes are identified as correlated with various breast cancer outcomes such that the levels of their expression are relevant to a determination of the preferred treatment protocols, of a breast cancer patient. Thus in one aspect, the invention provides a method to determine the outcome of a subject afflicted with, or suspected of having, breast cancer by assaying a cell containing sample from said subject for expression of the genes defined in SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL) as correlated with breast cancer outcomes.

A profile of genes that are highly correlated with one outcome relative to another may be used to assay an sample from a subject afflicted with, or suspected of having, breast cancer to predict the outcome of the subject from whom the sample was obtained. Such an assay may be used as part of a method to determine the therapeutic treatment for said subject based upon the breast cancer outcome identified.

The correlated genes SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL) are used in combination to increase the ability to accurately correlating a molecular expression phenotype with a breast cancer outcome. This correlation is a way to molecularly provide for the determination of survival outcomes as disclosed herein.

Over-expression of the genes defined in SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL) indicate that the patient has a high risk of developing metastases. The gene expression is profiled using an array of the polynucleotide probes defined in SEQ ID NO: 6, SEQ ID NO: 7, SEQ ID NO: 8, SEQ ID NO: 9, and SEQ ID NO: 10 that hybridize to the gene products (mRNA) of the genes defines in SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL).

The ability to discriminate is conferred by the identification of expression of the individual genes as relevant and not by the form of the assay used to determine the actual level of expression. An assay may utilize any identifying feature of an identified individual gene as disclosed herein as long as the assay reflects, quantitatively or qualitatively, expression of the gene in the “transcriptome” (the transcribed fraction of genes in a genome) or the “proteome” (the translated fraction of expressed genes in a genome). Identifying features include, but are not limited to, unique nucleic acid sequences used to encode (DNA), or express (RNA), said gene or epitopes specific to, or activities of, a protein encoded by said gene.

### DETAILED DESCRIPTION OF THE INVENTION

As outlined above the present invention is directed to a method for diagnosing/determining the risk of a breast cancer patient for developing metastases by establishing a differential expression of the genes SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL). In addition the present invention provides for a nucleotide array for prediction of risk of metastasis in breast cancer having probes specific for the genes SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL).

In the following the most important definitions of terms as used herein is provided.

A gene expression “pattern” or “profile” or “signature” refers to the relative expression of the genes SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL) between two or more breast cancer survival outcomes which is correlated with being able to distinguish between said outcomes.

A “gene” is a polynucleotide that encodes a discrete product, whether RNA or proteinaceous in nature. It is appreciated that more than one polynucleotide may be capable of encoding a discrete product. The term includes alleles and polymorphisms of a gene that encodes the same product, or a functionally associated (including gain, loss, or modulation of function) analog thereof, based upon chromosomal location and ability to recombine during normal mitosis.

The terms “correlate” or “correlation” or equivalents thereof refer to an association between expression of genes and a physiologic state of a breast cell to the exclusion of one or more other state as identified by use of the methods as described herein. A gene may be expressed at higher or lower levels and still be correlated with one or more breast cancer state or outcome.

A “polynucleotide” is a polymeric form of nucleotides of any length, either ribonucleotides or deoxyribonucleotides. This term refers only to the primary structure of the molecule. Thus, this term includes double- and single-stranded DNA and RNA. It also includes known types of modifications including labels known in the art, methylation, “caps”, substitution of one or more of the naturally occurring nucleotides with an analog, and internucleotide modifications such as uncharged linkages (e.g., phosphorothioates, phosphorodithioates, etc.), as well as unmodified forms of the polynucleotide.

The term “amplify” is used in the broad sense to mean creating an amplification product can be made enzymatically with DNA or RNA polymerases. “Amplification,” as used herein, generally refers to the process of producing multiple copies of a desired sequence, particularly those of a sample.

The terms “differentially expressed gene,” “differential gene expression” and their synonyms, which are used interchangeably, refer to a gene whose expression is activated to a higher or lower level in a subject suffering from a disease, specifically cancer, such as breast cancer, relative to its expression in a normal or control subject. The terms also include genes whose expression is activated to a higher or lower level at different stages of the same disease.

It is also understood that a differentially expressed gene may be either activated or inhibited at the nucleic acid level or protein level, or may be subject to alternative splicing to result in a different polypeptide product. Such differences may be evidenced by a change in mRNA levels, surface expression, secretion or other partitioning of a polypeptide, for example.

For the purpose of this invention, “differential gene expression” is considered to be present when there is at least a statistically significant difference between the expression of a given gene in normal and diseased subjects, or in various stages of disease development in a diseased subject.

For analysis of the microarray, it is preferable that the microarray also include “housekeeping” genes (control genes), or genes that are not affected by the same regulatory sequences, whose level of expression remains constant in the particular disease, state or disorder to be examined, so that the amount of expression can serve as a background level to be used for comparative purposes, to determine if a particular gene is turned on or off in that disease, disorder or other state to be examined.

Housekeeping genes are used to normalize results of expression. These are genes that are selected based on the relatively invariable levels of expression. Representative housekeeping genes include tyrosine 3-monooxygenase/tryptophan 5-monooxygenase activation protein, hypoxanthine phosphoribosyltransferase I (Lesh-Nyhan syndrome), Major histocompatibility complex, class 1, C, Ubiquitin C, Glyceraldehyde-3-phosphate dehydrogenase, Human mRNA fragment encoding cytoplasmic actin, 60S Ribosomal protein L I 3A, and Aldolase C.

An important aspect of the present invention is to use the measured expression of certain genes by breast cancer tissue to provide prognostic information. For this purpose it is necessary to correct for (normalize away) both differences in the amount of RNA assayed and variability in the quality of the RNA used. Therefore, the assay typically measures and incorporates the expression of certain normalizing genes, including well known housekeeping genes. Alternatively, normalization can be based on the mean or median signal of all of the assayed genes or a large subset thereof. On a gene-by-gene basis, measured normalized amount of a patient tumor mRNA is compared to the amount found in a breast cancer tissue reference set. The number of breast cancer tissues in this reference set should be sufficiently high to ensure that different reference sets behave essentially the same way. If this condition is met, the identity of the individual breast cancer tissues present in a particular set will have no significant impact on the relative amounts of the genes assayed.

To minimize errors and the effect of sample-to-sample variation, RT-PCR is usually performed using an internal standard. The ideal internal standard is expressed at a constant level among different tissues, and is unaffected by the experimental treatment.

A more recent variation of the RT-PCR technique is the real time quantitative PCR, which measures PCR product accumulation through a dual-labeled fluorigenic probe (i.e., TaqMan probe). Real time PCR is compatible both with quantitative competitive PCR, where internal competitor for each target sequence is used for normalization, and with quantitative comparative PCR using a normalization gene contained within the sample, or a housekeeping gene for RT-PCR. For further details see, e. g. Held et al., Genome Research 6:986-994 (1996).

A “microarray” is a linear or two-dimensional array of preferably discrete regions, each having a defined area, formed on the surface of a solid support such as, but not limited to, glass, plastic, or synthetic membrane. The density of the discrete regions on a microarray is determined by the total numbers of immobilized polynucleotides to be detected on the surface of a single solid phase support. As used herein, a DNA microarray is an array of oligonucleotides or polynucleotides placed on a chip or other surfaces used to hybridize to amplified or cloned polynucleotides from a sample. Since the position of each particular group of primers in the array is known, the identities of a sample polynucleotides can be determined based on their binding to a particular position in the microarray. The present inventors have surprisingly found that only a few control genes, such as “housekeeping” genes, are needed to reliable assess the differential expression of the genes of the present invention. It has been shown that only 10 control genes are needed in order to perform a correct assessment of whether genes of the present invention are differentially expressed or not. Preferably the present microarray incorporates 10-100, alternatively 10-1000 or 10-25000 control genes. In preferred embodiments of the invention the microarray incorporates, 100-500, 1000-2500, 5000-15000, or 20000-25000 control genes.

Because the invention relies upon the identification of genes that are differentially expressed, one embodiment of the invention involves determining expression by hybridization of mRNA, or an amplified or cloned version thereof, of a sample cell to a polynucleotide that is unique to a particular gene sequence.

Alternatively, and in another embodiment of the invention, gene expression may be determined by analysis of expressed protein in a cell sample of interest by use of one or more antibodies specific for one or more epitopes of individual gene products (proteins) in said cell sample. Such antibodies are preferably labeled to permit their easy detection after binding to the gene product.

The term “label” refers to a composition capable of producing a detectable signal indicative of the presence of the labeled molecule. Suitable labels include radioisotopes, nucleotide chromophores, enzymes, substrates, fluorescent molecules, chemiluminescent moieties, magnetic particles, bioluminescent moieties, and the like. As such, a label is any composition detectable by spectroscopic, photochemical, biochemical, immunochemical, electrical, optical or chemical means.

The term “support” refers to conventional supports such as beads, particles, dipsticks, fibers, filters, membranes and silane or silicate supports, such as glass slides.

As used herein, a “breast tissue sample” or “breast cell sample” refers to a sample of breast tissue or fluid isolated from an individual suspected of being afflicted with, or at risk of developing, breast cancer. Such samples are primary isolates (in contrast to cultured cells) and may be collected by any non-invasive means, including, but not limited to, ductal ravage, fine needle aspiration, needle biopsy, or any other suitable means recognized in the art. Alternatively, the “sample” may be collected by an invasive method, including, but not limited to, surgical biopsy.

“Detection” includes any means of detecting, including direct and indirect detection of gene expression and changes therein. For example, “detectably less” products may be observed directly or indirectly, and the term indicates any reduction (including the absence of detectable signal). Similarly, “detectably more” product means any increase, whether observed directly or indirectly.

The term “diagnosis” is used herein to refer to the identification of a molecular or pathological state, disease or condition, such as the identification of a molecular subtype of head and neck cancer, colon cancer, or other type of cancer.

The term “prognosis” is used herein to refer to the prediction of the likelihood of cancer-attributable death or progression, including recurrence and metastatic spread.

The term “prediction” is used herein to refer to the likelihood that a patient will respond either favorably or unfavorably to a drug or set of drugs, and also the extent of those responses, or that a patient will survive, following surgical removal or the primary tumor and/or chemotherapy for a certain period of time without cancer recurrence. The predictive methods of the present invention can be used clinically to make treatment decisions by choosing the most appropriate treatment modalities for any particular patient. The predictive methods of the present invention are valuable tools in predicting if a patient is likely to respond favorably to a treatment regimen, such as surgical intervention, chemotherapy with a given drug or drug combination, and/or radiation therapy, or whether long-term survival of the patient, following surgery and/or termination of chemotherapy or other treatment modalities is likely.

The present invention relates to the identification and use of a gene expression pattern (or profile or “signature”) based on the genes SEQ ID NO: 1 (FLJ20354), SEQ ID NO: 2 (IMAGE:4081483), SEQ ID NO: 3 (UBE2R2), SEQ ID NO: 4 (ZNF533), and SEQ ID NO: 5 (DTL), which discriminates between (or are correlated with) breast cancer survival and recurrence outcomes in a subject.

To determine the (increased or decreased) expression levels of genes in the practice of the present invention, any method known in the art may be utilized. In one preferred embodiment of the invention, expression based on detection of RNA which hybridizes to the genes identified and disclosed herein is used. This is readily performed by any RNA detection or amplification+detection method known or recognized as equivalent in the art such as, but not limited to, reverse transcription-PCR, and methods to detect the presence, or absence, of RNA stabilizing or destabilizing sequences.

Expression based on detection of a presence, increase, or decrease in protein levels or activity may also be used. Detection may be performed by any immunohistochemistry (IHC) based, blood based (especially for secreted proteins), antibody (including autoantibodies against the protein) based, exfoliate cell (from the cancer) based, mass spectroscopy based, and image (including used of labeled ligand) based method known in the art and recognized as appropriate for the detection of the protein. Antibody and image based methods are additionally useful for the localization of tumors after determination of cancer by use of cells obtained by a non-invasive procedure (such as ductal ravage or fine needle aspiration), where the source of the cancerous cells is not known. A labeled antibody or ligand may be used to localize the carcinoma(s) within a patient.

A preferred embodiment using a nucleic acid based assay to determine expression is by immobilization of one or more sequences of the genes identified herein on a solid support, including, but not limited to, a solid substrate as an array or to beads or bead based technology as known in the art. Alternatively, solution based expression assays known in the art may also be used. The immobilized genes may be in the form of polynucleotides that are unique or otherwise specific to the genes such that the polynucleotides would be capable of hybridizing to a DNA or RNA corresponding to the genes.

The present invention provides a more objective set of criteria, in the form of gene expression profiles of a discrete set of genes, to discriminate (or delineate) between breast cancer outcomes. In particularly preferred embodiments of the invention, the assays are used to discriminate between good and poor outcomes within 5, or about 5, years after surgical intervention to remove breast cancer tumors.

While good and poor survival outcomes may be defined relatively in comparison to each other, a “good” outcome may be viewed as a better than 50% survival rate after about 60 months post surgical intervention to remove breast cancer tumor(s). A “good” outcome may also be a better than about 60%, about 70%, about 80% or about 90% survival rate after about months post surgical intervention. A “poor” outcome may be viewed as a 50% or less survival rate after about 60 months post surgical intervention to remove breast cancer tumor(s). A “poor” outcome may also be about a 70% or less survival rate after about 40 months, or about a 80% or less survival rate after about 20 months, post surgical intervention.

In one embodiment of the invention, the isolation and analysis of a breast cancer cell sample may be performed as follows:
(1) Ductal lavage or other non-invasive procedure is performed on a patient to obtain a sample.
(2) Sample is prepared and coated onto a microscope slide.
(3) Pathologist or image analysis software scans the sample for the presence of non-normal and/or atypical breast cancer cells.
(4) If such cells are observed, those cells are harvested (e.g. by microdissection).
(5) RNA is extracted from the harvested cells.
(6) RNA is purified, amplified, and labeled.
(7) Labeled nucleic acid is contacted with a microarray containing polynucleotides of the genes identified herein as correlated to discriminations between breast cancer outcomes under suitable hybridization conditions, then processed and scanned to obtain a pattern of intensities of each spot (relative to a control for general gene expression in cells) which determine the level of expression of the genes in the cells.
(8) The pattern of intensities is analyzed by comparison to the expression patterns of the genes in known samples of breast cancer cells correlated with outcomes (relative to the same control).

A specific example of the above method would be performing ductal lavage following a primary screen, observing and collecting non-normal and/or atypical cells for analysis. The comparison to known expression patterns, such as that made possible by a model generated by an algorithm with reference gene expression data for the different breast cancer survival outcomes, identifies the cells as being correlated with subjects with good or poor outcomes.

Another example would be taking a breast tumor removed from a subject after surgical intervention, isolation and preparation of breast cancer cells from the tumor for determination/identification of atypical, non-normal, or cancer cells, and isolation of said cells followed by steps 5 through 8 above.

Alternatively, the sample may permit the collection of both normal as well as cancer cells for analysis. The gene expression patterns for each of these two samples will be compared to each other as well as the model and the normal versus individual comparisons therein based upon the reference data set.

With use of the present invention, skilled physicians may prescribe treatments based on prognosis determined via non-invasive samples that they would have prescribed for a patient which had previously received a diagnosis via a solid tissue biopsy.

The above discussion is also applicable where a palpable lesion is detected followed by fine needle aspiration or needle biopsy of cells from the breast. The cells are plated and reviewed by a pathologist or automated imaging system which selects cells for analysis as described above.

The present invention may also be used, however, with solid tissue biopsies. For example, a solid biopsy may be collected and prepared for visualization followed by determination of expression of one or more genes identified herein to determine the breast cancer outcome. One preferred means is by use of in situ hybridization with polynucleotide or protein identifying probes for assaying expression of said genes.

In an alternative method, the solid tissue biopsy may be used to extract molecules followed by analysis for expression of the genes of the present invention. This provides the possibility of leaving out the need for visualization and collection of only cancer cells or cells suspected of being cancerous. This method may of course be modified such that only cells that have been positively selected are collected and used to extract molecules for analysis. This would require visualization and selection as a prerequisite to gene expression analysis.

In a further modification of the above, both normal cells and cancer cells are collected and used to extract molecules for analysis of gene expression. The approach, benefits and results are as described above using non-invasive sampling.

The genes identified herein may be used to generate a model capable of predicting the breast cancer survival and recurrence outcomes of an unknown breast cell sample based on the expression of the identified genes in the sample. Such a model may be generated by any of the algorithms described herein or otherwise known in the art as well as those recognized as equivalent in the art using genes disclosed herein for the identification of breast cancer outcomes.

The detection of gene expression from the samples may be by use of a single microarray able to assay gene expression from some or all genes disclosed herein for convenience and accuracy. Other uses of the present invention include providing the ability to identify breast cancer cell samples as correlated with particular breast cancer survival or recurrence outcomes for further research or study. This provides a particular advantage in many contexts requiring the identification of cells based on objective genetic or molecular criteria.

The materials for use in the methods of the present invention are ideally suited for preparation of kits produced in accordance with well known procedures. The invention thus provides kits comprising agents for the detection of expression of the disclosed genes for identifying breast cancer outcomes. Such kits optionally comprising the agent with an identifying description or label or instructions relating to their use in the methods of the present invention, is provided. Such a kit may comprise containers, each with one or more of the various reagents (typically in concentrated form) utilized in the methods, including, for example, pre-fabricated microarrays, buffers, the appropriate nucleotide triphosphates (e.g., dATP, dCTP, dGTP and dTTP, or rATP, rCTP, rGTP and UTP), reverse transcriptase, DNA polymerase, RNA polymerase, and one or more primer complexes of the present invention (e.g., appropriate length poly(T) or random primers linked to a promoter reactive with the RNA polymerase). A set of instructions will also typically be included.

The methods provided by the present invention may also be automated in whole or in part. All aspects of the present invention may also be practiced such that they consist essentially of a subset of the disclosed genes to the exclusion of material irrelevant to the identification of breast cancer survival outcomes via a cell containing sample.

Having now generally described the invention, the same will be more readily understood through reference to the following examples which are provided by way of illustration, and are not intended to be limiting of the present invention, unless specified.

### BRIEF DESCRIPTION OF THE DRAWINGS

FIG. 1 shows the probability of metastasis calculated by SVM using leaving one-pair out cross-validation based on the 32-gene signature by PAM (1a), the 5-gene signature by the method of the present invention (1b) and the 43-gene signature by paired t-test (1c) for the 13 pairs of low-malignant T1 (asterisk) and 17 pairs of low-malignant T2 (triangle) patients. The best performance is achieved by the 5-gene signature of the present invention with improved prediction accuracy and better separation.

FIG. 2 shows ROC analysis for model comparison with the curves for the present method (New method), for PAM (PAM) and for the paired t-test (Paired T-test). The new method exhibits higher efficiency in its performance. The high AUC for our new method (0.86) indicates that it outperforms PAM (AUC=0.83) and the paired t-test (AUC=0.80).

### EXAMPLE

Generation of Microarrays

3-D activated CodeLink glass slides for arraying (manufactured by Surmodics, Inc., Eden Praire, Minn.) were purchased from Amersham Bioscience. The slides are coated with a long-chain, hydrophilic polymer containing amine-reactive groups permitted to covalently attach to 50 amino modified ends of oligonucleotide targets. In a series of experiments, humidity, spotting time, and pin performance were tested with a panel of 18 test oligonucleotides. A human oligonucleotide library composed of 29,134 oligonucleotide targets (60-mers) recognising 28,830 genes (designed by Compugen Ltd., Jamesburg, N.J.) and with a 50 amino linker modification was purchased from Sigma-Genosys (The Woodlands, Tex.). The oligonucleotides have been designed to include known genes, expressed sequence tags, and the majority of known alternative splice variants (http://www.labonweb.com/oligo). The polynucleotides comprise probes defined in SEQ ID NO: 6, SEQ ID NO: 7, SEQ ID NO: 8, SEQ ID NO: 9, and SEQ ID NO: 10, which hydridise to the transcription products of the genes defined in SEQ ID NO: 1, SEQ ID NO: 2, SEQ ID NO: 3, SEQ ID NO: 4, and SEQ ID NO: 5. According to the CodeLink protocol, oligonucleotide targets were solubilised in 150 mM sodium phosphate buffer (pH 8.5) at a final concentration of 20 pmol/l. Oligonucleotide targets were arrayed in duplicate by a spotting robot (Virtek ChipWriter Pro (ESI)) onto 50 slides in a controlled environment with a humidity of 38% inside the spotting compartment.

Duplicate spots were 9 mm apart. 24 SMP 2.5 stealth pins (TeleChem International Inc., Sunnyvale, USA) were used for printing and each spot was about 100 micrometer in diameter and spot centres were 124 micrometer apart. After printing, slides were incubated overnight at 70% humidity and blocked as recommended by the manufacturer. Dried microarray slides were stored in a desiccated environment at room temperature.

Preparation of cDNA and cRNA

Universal human reference RNA was a source for hybridisation to the slides described previously and was prepared according to the manufacturer's protocol (Stratagene, Calif., USA). Labelling of cDNA probes. 10 microgram of universal reference RNA was added to DEPC treated water to a final volume of 12 microliter and amino allyl modified cDNA was prepared and purified using the FairPlay Microarray Labelling Kit (Stratagene, Calif.). Coupling of the fluorescent dyes Cy3 and Cy5 (Amersham Bioscience) to the modified cDNA and subsequent purification was done using the same kit. The volume of purified labeled cDNA was reduced to 20 microliter using centrifugation under vacuum.

Labelling of cRNA

Probes were prepared from 2 microgram universal reference RNA using the Ambion (Austin Tex., USA) Amino Allyl MessageAmp RNA kit (referred to as MessageAmp) as described in the manual. Briefly, cDNA synthesis was performed with oligo(dT) primers also containing a T7 RNA polymerase recognition site. After second cDNA strand synthesis, amplification was performed with T7 RNA polymerase and the resulting aRNA was purified with filter cartridges included in the kit. An aliquot of 15 microgram aRNA was labelled with Cy5 fluorescent NHS-esters. Aliquots of 15 microgram aRNA were transferred from all samples and pooled to use as a reference and labeled with Cy3. The labelled aRNA was purified with filter cartridges to remove unbound dyes and 2.6 microgram of Cy3 labeled aRNA was added to 2.6 microgram of each Cy5 labeled sample. Samples were fragmented using 1 microliter Fragmentation Reagent (Ambion) followed by incubation for 15 min at 70° C. One microliter of stop solution was used to terminate the reaction.

Preparation of Spike RNA

A cDNA sequence from Trichoplusiani (Accession No. AY345124) was obtained from NCBI and blasted against the human genome resulting only in hits with very low homology. The software Oligowiz was used to design an oligonucleotide with the following sequence:

tctatttctgcgctggtggtgtgatttgtgattggccgcagaacgtaaactgtaacagcagaatgttctttgctgctctcagaatcacg ccagctactaag. This oligonucleotide was PCR amplified with the forward primer: taatacgactcactatagggagatctatttctgcgctggtggtg including a T7 polymerase recognition site and the lower primer tttttttttttttttttttttttttcttagtag ctggcgtgattc including a poly(dT) sequence stretch. The PCR product was used as template for in vitro transcription with the T7 MEGAscript kit (Ambion). The resulting RNA was spiked in 10-fold dilutions into aliquots of total RNA, processed with the MessageAmp kit and aRNA was hybridised to chips containing a complementary sequence (underlined sequence). The linear range of the system was examined by plotting the signal from the spots as a function of initial amount of spike RNA.

Hybridisation and Scanning

Hybridisation and washing were performed identically for all arrays. Each cDNA or cRNA mixture was adjusted to 4×SSC, 0.1% SDS, and 0.1 microgram/microliter sonicated salmon sperm DNA (Stratagene) in a final volume of 80 microliter. Samples were denatured for 2 min at 95° C. and spun at 14,000 rpm for 5 min to remove precipitated probe.

Samples were hybridised to microarray slides using lifter slips (Erie) as covers and placed in humidified CMT-hybridisation chambers (Corning Inc., Corning, N.Y.). Hybridisation was done overnight at 42° C. in a water bath for 17 h. After hybridisation, slides were removed from the chambers and lifter slips were gently removed from the slides by soaking in 4×SSC in a wash station (TeleChem International Inc., Sunnyvale, USA). Slides were washed by immersion into 2×SSC, 0.1% SDS twice at hybridisation temperature for 5 min, in 0.2×SSC and 0.1×SSC, each of them at room temperature, for 1 min, and dried by centrifugation at 1000 rpm for 5 min. Detection of Cy3 and Cy5 fluorescence signals was performed on an ArrayWoRxe CCD scanner (Applied Precision), and images were generated for the Cy3 and Cy5 channels with the accompanying ArrayWoRxe software.

Data Preprocessing

Identification of spot locations and quantification were performed using ArrayWoRx software. Approximately 80% of each spot area was used for quantification of Cy3 and Cy5 fluorescence signals. The raw intensity data were corrected for local background and normalised using the variance stabilization normalization procedure implemented in the R based Bioconductor package (http://www.bioconductor.org). Outputs of the procedure are normalised expression values in log scale (base 2) for Cy3 and Cy5 signals (log2Icy3, log2Icy5).

Data Analysis

For descriptive analysis of accuracy, median and 95% intervals were calculated for the relative expression. Precision was determined as 95% intervals and coefficient of variation (CV) of the ratios of relative expression values or ratios of single channel data between pairs of chips. By treating each spot on an array as an object and the arrays as repeated measurements for the objects, the intraclass correlation coefficient (ICC) was introduced to examine the reproducibility of the arrays and for comparing the ICCs between the chips made using different labelling methods (MessageAmp or FairPlay). In order to compare the ICCs between the two labelling methods, a computer re-sampling approach was employed by bootstrapping the spots on the arrays to obtain empirical distributions of the observed ICCs. In addition, the analysis of variance (ANOVA) model was introduced to detect the day as well as the labelling effects on gene expression variation for each gene. The false discovery rate (FDR) (Reiner et al. 2003) was calculated to adjust for multiple testing. In order to assess sequence variation in relative expression values within and across the arrays, the mean square (MS) for intra-chip variation was calculated.

The method of the present invention is applied to a microarray dataset on tumor metastasis from low-malignant breast cancer patients collected in our lab (Thomassen et al. 2006a). In this study, 13 low-malignant T1 (tumor size in diameter T≦20 mm) and 17 low-malignant T2 (20 mm<T≦50 mm) tumors from patients who developed metastases were matched to metastasis-free tumors from patients (followed up for about 12 years after diagnosis) of the same tumor type and according to year of surgery, tumor size, and age. Gene expression analysis was performed on 29K oligonucleotide arrays with duplicated measurements for each gene (Thomassen et al. 2006b). Data were normalized using the variance stabilization normalization method (Huber et al. 2002) implemented in the free R package vsn in Bioconductor (http://www.bioconductor.org).

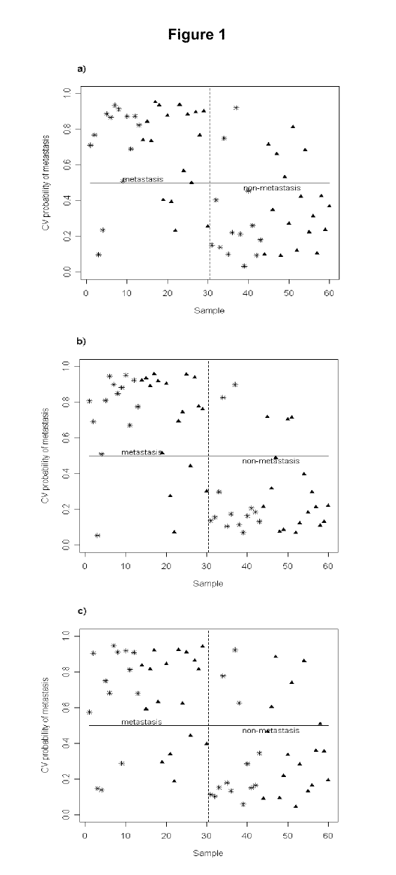

The study by Thomassen et al. (2006a) identified a 32-gene signature that classifies the 60 tumor samples with a mean accuracy of 78% (specificity 77%; sensitivity 80%) using leaving one-pair out cross-validation (FIG. 1a). In the analysis, feature selection was done using the nearest shrunken centroids methods in the R package pamr (Tibshirani et al. 2002) and classification done using SVM in the R package e1071. It should be noted that the feature selection procedure using pamr does not take the paired matching into account in identifying the subset of genes for training and prediction.

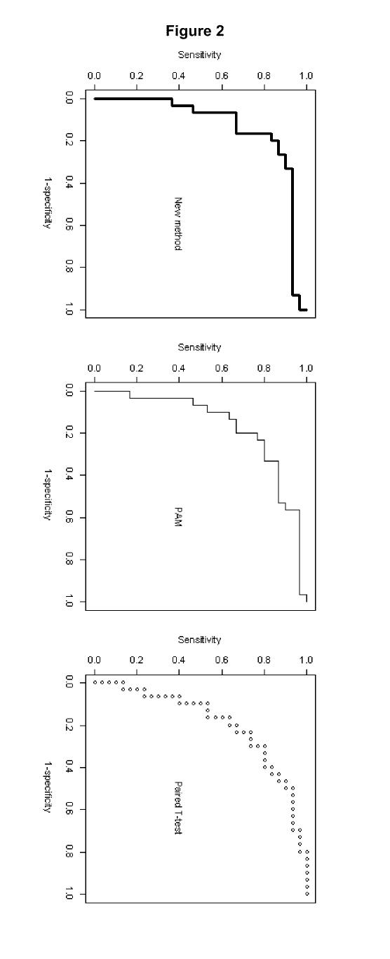

Using the method of the present invention the data are re-analyzed by introducing the modified t-statistic for paired data in defining the gene expression signature for predicting metastases. The analysis achieved an overall accuracy of 83% (Δ=0.396) with a specificity of 83% and a sensitivity of 83% using a subset of only 5 genes (FIG. 1b), namely the genes defined in SEQ ID NO: 1, SEQ ID NO: 2, SEQ ID NO: 3, SEQ ID NO: 4, and SEQ ID NO: 5. Comparing FIGS. 1a with 1b, one can see that the method of the present invention has improved separation based on prediction probability and increased efficiency (median of correct prediction probability: 0.88 versus 0.86 for metastasis and 0.84 versus 0.81 for non-metastasis). For further comparison the ordinary paired t-test for gene selection is introduced. Here the thresholding is imposed upon the ordinary paired t-statistic, i.e. genes with |ti|−Δ>0 are picked up. Likewise, the optimal subset of genes through cross-validation by leaving one-pair out is selected. The classifier based on the expression signature specified by the ordinary paired t-test yields an average accuracy of 74% (specificity 74%; sensitivity 74%) when Δ is set to 3.1 (43 genes selected). The cross-validation probabilities plotted in FIG. 1c shows that the model based on ordinary paired t-test has the lowest efficiency (median of correct prediction probability: 0.85 for metastasis and 0.83 for non-metastasis) even though the method makes use of the paired design. The overall performances of the 3 methods using ROC analysis was finally evaluated. Based on the cross-validation probability of metastasis from SVM and the observed metastasis status for each sample, one is able to draw the ROC curves and show it in FIG. 2 with the curves for the new method, for PAM, and for the paired t-test. Visualization of FIG. 2 indicates that the method of the present invention exhibits higher efficiency as compared with the others. This is further confirmed by calculating the AUC, a standard summary metric for assessing the overall performance of a classifier. The high AUC for the herewith invented method (0.86) again shows that it outperforms PAM (AUC=0.83) and the ordinary paired t-test (AUC=0.80).

The present inventors have therefore introduced a simple feature selection method for predicting tumor metastases in paired microarray experiments. Model comparison through empirical application shows that the method manifests high efficiency and outperforms existing methods. As shown, the ordinary paired t-tests has the worst performance as compared with the other two methods which use modified t-statistics for thresholding to eliminate genes that do not contribute towards class prediction. Although both the modified and the ordinary paired t-statistics make use of the matched design, the better performance of the method of the present invention is achieved by thresholding upon a new metric that is less dependent on gene-specific variances which helped to filter statistically significant genes due to small standard errors in their differential expressions.

It is more interesting to compare the performances between the present method and PAM. Although both methods use the modified versions of t-statistics, the present method takes the following advantages of the paired design in selecting informative features. First, as a popular method in cancer research (Breslow and Day, 1990), the paired design helps to minimize the influence on tumor metastasis from non-transcriptomic factors such as age, clinical stage, treatment, etc (Gonzalez-Angulo et al. 2005).

Second, in a transcriptomic study on tumor metastasis, these confounding factors not only affect the metastasis phenotype which is of our primary interest but could also influence the transcriptional profiles of genes. Ignoring these influences will simply introduce noise in feature selection resulting in low accuracy of the classifier.

A good classification signature should be a minimal subset of genes that is not only differentially expressed but also contains most relevant genes without redundancy (Peng et al. 2006; Baker and Kramer, 2006). A comparative analysis on data across several studies has found that classification rules for the 5 genes of the present invention can achieve comparable performance as that for 20 or 50 genes (Baker and Kramer, 2006).

Finally, it is necessary to point out that the paired experiment design in studying tumor metastasis using two-channel cDNA microarrays can be further advantaged by the reduced experimental cost when directly labeling, for example, metastasis mRNA with cy5 and non-metastasis mRNA with cy3 in each matched pair. Since the method of the present invention works with the pair-wised difference in the log expression values, the feature selection algorithm is valid for both one- and two-channel microarray platforms.

1. An array comprising polynucleotide probes capable of hybridizing to transcription products of the genes defined in SEQ ID NO: 1, SEQ ID NO: 2, SEQ ID NO: 3, SEQ ID NO: 4, and SEQ ID NO: 5 derived from a breast cancer cell, said array embodying polynucleotide probes being able to determine the expression level for said genes, wherein the expression level is normalized against 10-100 control genes based on polynucleotide control probes in the array that are capable of hybridizing to the control genes.

2. The array of claim 1, wherein said gene expression level is determined through hybridization of the transcription products of the genes defined in SEQ ID NO: 1, SEQ ID NO: 2, SEQ ID NO: 3, SEQ ID NO: 4, and SEQ ID NO: 5 with the polynucleotide probes defined in SEQ ID NO: 6, SEQ ID NO: 7, SEQ ID NO: 8, SEQ ID NO: 9, and SEQ ID NO: 10.

3. A method of predicting an increase risk of metastasis of a subject having breast cancer by establishing an over expression of the genes defined in SEQ ID NO: 1, SEQ ID NO: 2, SEQ ID NO: 3, SEQ ID NO: 4, and SEQ ID NO: 5, said method comprising assaying for the expression levels of said genes in a breast cancer cell from said subject.

4. The method of claim 3, wherein said assaying comprises preparing RNA from said sample and probing this RNA with polynucleotide probes being able to determine the expression level for said genes.

5. The method of claim 4, wherein said RNA is used for quantitative PCR.

6. The method of claim 3, wherein said assaying involves the polynucleotide probes defined in SEQ ID NO: 6, SEQ ID NO: 7, SEQ ID NO: 8, SEQ ID NO: 9, and SEQ ID NO: 10.

7. The method of claim 3, wherein said sample is a ductal lavage or fine needle aspiration sample.

8. The method of claim 7, wherein said sample is microdissected to isolate one or more cells suspected of being breast cancer cells.

9. The method of claim 8, wherein said assaying comprises preparing RNA from said cell and optionally using said RNA for quantitative PCR.

10. A method to determine therapeutic treatment for a breast cancer patient based upon said patient's expected survival, said method comprising determining a survival outcome for said patient by assaying a sample of breast cancer cells from said patient for the expression levels of the genes defined in SEQ ID NO: 1, SEQ ID NO: 2, SEQ ID NO: 3, SEQ ID NO: 4, and SEQ ID NO: 5; and selecting the appropriate treatment for a patient with such a survival outcome.

11. The method of claim 10, wherein said assaying comprises preparing RNA from said cells.

12. The method of claim 11, wherein said RNA is used for quantitative PCR.

13. The method of claim 12, wherein said assaying involves the polynucleotide probes defined in SEQ ID NO: 6, SEQ ID NO: 7, SEQ ID NO: 8, SEQ ID NO: 9, and SEQ ID NO: 10.

14. The method of claim 10, wherein said sample is a ductal lavage or fine needle aspiration sample.

15. The method of claim 14, wherein said sample is microdissected to isolate one or more cells suspected of being breast cancer cells.
